(19) United States
(12) Patent Application Publication
(10) Pub. No.: US 2026/0310165 A1
(43) Pub. Date: Oct. 8, 2026

(54) SYSTEM AND METHOD FOR GENERATIVE DESIGN AND ADDITIVE MANUFACTURING OF NON-NEWTONIAN SMART MATERIALS FOR ENERGY ABSORPTION

(71) Applicant: Nano and Advanced Materials Institute Limited, Hong Kong (HK)

(72) Inventors: Mei Shan CHAN, Hong Kong (HK); Xiyao ZHANG, Hong Kong (HK); Pak Chung LAU, Hong Kong (HK); Kang ZHANG, Hong Kong (HK); Jifan LI, Hong Kong (HK)

(21) Appl. No.: 19/298,230

(22) Filed: Aug. 13, 2025

Related U.S. Application Data
(60) Provisional application No. 63/785,016, filed on Apr. 8, 2025.

(51) Int. Cl. G05B 19/4099; B29C 64/112; B29C 64/386; B29L 31/00; B29L 31/30; B33Y 10/00; B33Y 50/00; B33Y 80/00

(52) U.S. Cl. CPC G05B 19/4099; B29C 64/112; B29C 64/386; B33Y 10/00; B33Y 50/00; B29L 2031/3097; B29L 2031/768; B33Y 80/00; G05B 2219/35134; G05B 2219/49023

(57) ABSTRACT

The present invention relates to a system and method for generative design and additive manufacturing of non-Newtonian smart materials optimized for energy absorption. The system includes a generative design module that creates candidate structures based on rheological inputs, a finite element analysis (FEA) module that simulates performance using strain rate-sensitive models, and an additive manufacturing module that fabricates the optimized structures. Designs are represented as voxel meshes and converted into signed distance fields (SDFs) for simulation and comparison. An optimization process iteratively refines structural features such as unit cell size, density, and hole geometry to meet impact performance and manufacturing constraints. This integrated approach enables automated generation of high-performance, printable structures for protective applications.

### CROSS-REFERENCE TO RELATED APPLICATIONS

The present application claims priority from a U.S. provisional patent application Ser. No. 63/785,016 filed Apr. 8, 2025, and the disclosure of which is incorporated herein by reference in its entirety.

### TECHNICAL FIELD

The present invention generally relates to the fields of structural mechanics and smart materials, additive manufacturing, impact engineering, rheology, computer science and data analysis; more specifically, it is directed to systems and methods for generative design and additive manufacturing of non-Newtonian smart materials for energy absorption.

### BACKGROUND

Energy-absorbing materials are critical for various applications, such as protections for equipment, machinery, automotive components, aerospace structures, and all things moving. Traditional approaches for designing energy-absorbing structures often rely on manipulating geometric features, such as honeycombs or lattice structures, to manage the dissipation of kinetic energy during impact. However, these techniques often reach performance limitations due to factors like material density, manufacturability, and the ability to adapt to varying impact conditions. Materials exhibiting non-Newtonian behavior, where viscosity changes with shear rate, offer significant potential for enhanced energy absorption. Their ability to stiffen under high strain rates can provide superior impact protection compared to traditional Newtonian materials. However, designing structures with non-Newtonian materials presents significant challenges. The complex relationship between material properties, geometry, and dynamic loading conditions makes it difficult to predict and optimize energy absorption performance using conventional design methods.

Current computational tools often rely on simplified material models that fail to capture the complex rheological behavior of non-Newtonian materials. This limitation hinders the accurate prediction of energy absorption under realistic impact scenarios. Furthermore, existing design optimization techniques often struggle to handle the non-linearity introduced by non-Newtonian material models, making it difficult to efficiently explore the design space and identify optimal solutions.

Additive manufacturing (AM) technologies offer the potential to fabricate complex geometries, enabling the realization of advanced energy-absorbing structures. However, effectively integrating AM with non-Newtonian material design requires a sophisticated approach that considers both the material's unique behavior and the manufacturing constraints imposed by the AM process.

Therefore, there exists a need for improved systems and methods for designing and manufacturing energy-absorbing structures using non-Newtonian materials that address the limitations of current design and fabrication techniques.

### SUMMARY OF INVENTION

The present invention aims to fulfill the need above by providing an integrated approach that combines generative design, advanced Finite Element Analysis (FEA) with non-Newtonian material models, and additive manufacturing.

The present invention provides a system and method for the generative design and additive manufacturing of non-Newtonian smart materials optimized for energy absorption. The system and method address the limitations in the current state of the art by integrating advanced computational design, simulation, and fabrication techniques. Furthermore, the invention employs a signed distance field (SDF) representation to provide an intrinsic characterization of the design, facilitating shape and topology comparisons independent of specific geometric parameters.

In accordance with a first aspect of the present invention, a system for designing and manufacturing non-Newtonian energy-absorbing structures is provided. The system is configured to receive user-defined input parameters and to generate physical structures through an integrated design-to-fabrication workflow. The system includes a user interface, a generative design module, a database, and a FEA module. The user interface is configured to receive input parameters comprising material properties, loading conditions, and geometric constraints and to convert the input parameters into structured data. The generative design module is configured to receive the structured data and to generate candidate structures using a 3D conditional diffusion model that synthesizes voxel-based geometries based on physical and rheological characteristics of a selected non-Newtonian material. The dataset includes experimentally derived rheological data, which comprises viscosity curves, viscoelastic moduli, and manufacturing parameters. The rheological data is provided to the generative design module during generation of the candidate structures. The FEA module is configured to simulate mechanical performance of the candidate structures using material models specific to non-Newtonian behavior and a voxel mesh resolution consistent with an additive manufacturing process.

In accordance with a second aspect of the present invention, a method for designing and manufacturing non-Newtonian energy-absorbing structures is provided. The method is designed for receiving user-defined input parameters and generating physical structures through an integrated design-to-fabrication workflow. The method includes the steps as follows: receiving, via a user interface, input parameters comprising material properties, loading conditions, and geometric constraints and to convert the input parameters into structured data; receiving, by a generative design module, the structured data; generating, by the generative design module, candidate structures using a 3D conditional diffusion model that synthesizes voxel-based geometries based on physical and rheological characteristics of a selected non-Newtonian material; storing, in a database, a dataset including experimentally derived rheological data comprising viscosity curves, viscoelastic moduli, and manufacturing parameters; providing the rheological data to the generative design module during generation to the candidate structures; and simulating, by a FEA module, mechanical performance of the candidate structures using material models specific to non-Newtonian behavior and a voxel mesh resolution consistent with an additive manufacturing process.

By the configuration, several key advantages are achieved, including:

Improved energy absorption: the integration of advanced design, simulation, and manufacturing techniques results in structures with superior energy absorption characteristics.

Automated design and fabrication: the system streamlines the entire process, reducing design time and costs.

Material-specific optimization: the focus on non-Newtonian materials ensures that their unique properties are fully utilized in the final designs.

Versatility: the system can be applied across a wide range of industries, including protective equipment, automotive, and aerospace.

### BRIEF DESCRIPTION OF DRAWINGS

Embodiments of the invention are described in more details hereinafter with reference to the drawings, in which:

FIG. 1 demonstrates a schematic block diagram illustrating the overall architecture of a system according to some embodiments of the present invention;

FIG. 2 is a flowchart illustrating an internal process of a 3D conditional diffusion model implemented within the generative design module according to one embodiment;

FIG. 3 is a flowchart illustrating a mesh-to-3D image conversion process performed within the generative design module according to one embodiment;

FIG. 4 is a flowchart illustrating a calibration algorithm process implemented within the optimization module according to one embodiment;

FIG. 5 is a flowchart illustrating an optimization algorithm process performed within the optimization module according to one embodiment;

FIG. 6 provides an example of an optimized design. The illustrated voxel-based structures represent generative outputs that are labeled with relative density and energy absorption per unit volume;

FIG. 7 shows the training loss and validation loss curves of the AI model used in the generative design module; and

FIG. 8 illustrates the prediction performance of the AI model used in the generative design module.

### DETAILED DESCRIPTION OF THE INVENTION

In the following description, systems and methods for generative design and additive manufacturing of non-Newtonian smart materials for energy absorption and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

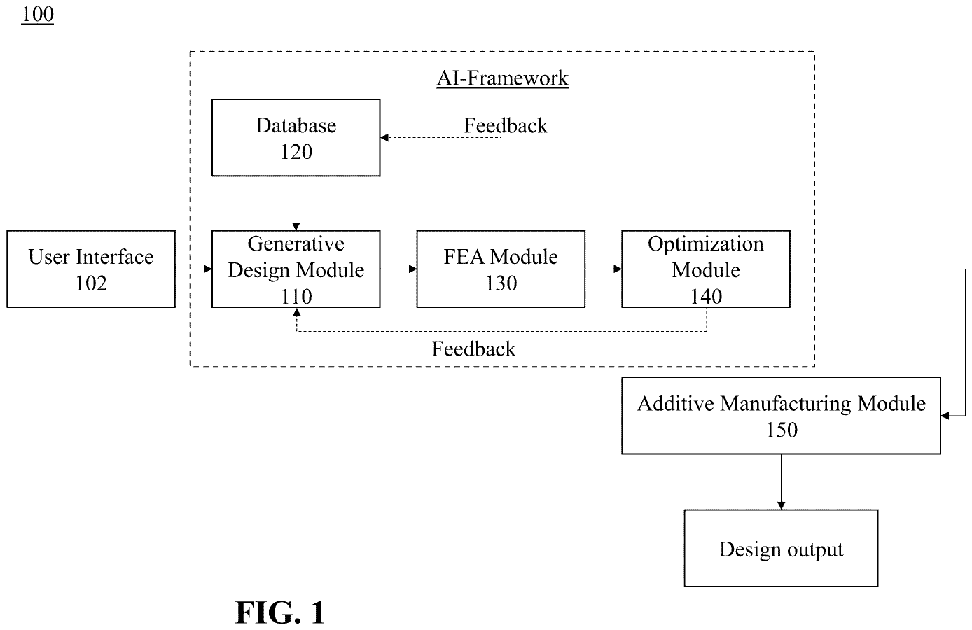

FIG. 1 demonstrates a schematic block diagram illustrating the overall architecture of a system 100 according to some embodiments of the present invention. Referring to FIG. 1, the system 100 is provided for the generative design and additive manufacturing of non-Newtonian energy-absorbing and protective structures. The system 100 is suitable for a variety of scenarios, including but not limited to those involving structural mechanics, smart material systems, additive manufacturing, impact engineering, rheology, computer science, and data analysis. The system 100 can be deployed in scenarios where products are designed and fabricated using non-Newtonian materials, such as protective equipment, energy-dissipating panels, or lightweight aerospace structures. The system 100 may also be used in simulation-based workflows where material behavior is modeled, structures are generated through computational design, and performance is evaluated under dynamic loading conditions.

The system 100 includes a user interface 102, a generative design module 110, a database 120, a finite element analysis (FEA) module 130, an optimization module 140, and an additive manufacturing module 150. In this architecture, the generative design module 110, the dataset 120, the FEA module 130, and the optimization module 140 constitute an artificial intelligence-based (AI-based) design framework.

The user interface 102 provides a platform for users to define design objectives and material constraints in an accessible and structured manner. The user interface 102 allows users to input key parameters such as target energy absorption, geometric boundaries, loading conditions, and specific rheological characteristics of the material to be used. The user interface 102 is further configured to translate these human-readable inputs into a machine-readable and structured data format, which can be parsed and processed by downstream modules within the system. For example, this formatted data serves as the foundational input for the generative design module 110.

The generative design module 110 is configured to generate candidate structures based on formatted input parameters received from the user interface 102. These parameters may include energy absorption targets, unit cell size, geometric constraints, loading conditions, and rheological characteristics specific to a selected non-Newtonian material. As a core AI-driven component, the generative design module 110 integrates a 3D conditional diffusion model that functions as a machine learning-based generation engine.

The 3D conditional diffusion model leverages noise tensors and conditioning vectors derived from the input parameters to iteratively construct voxel-based structural geometries that are responsive to material behaviors such as shear-rate-dependent viscosity and process-specific limitations.

The generative design module 110 further applies a structure representation method, such that the generated structures are represented as tetrahedral meshes and are further converted into signed distance fields (SDFs), providing a consistent and differentiable format for downstream simulation, optimization, and topological analysis. Specifically, the generated designs are initially represented as tetrahedral meshes and are subsequently converted into SDFs. This conversion involves extracting the oriented closed surface of each structure and calculating the signed distance from each point on a Cartesian grid to the nearest surface location.

The structural features, including unit cell size, density, hole size, and shape, are defined with careful consideration of the liquid-phase characteristics of the non-Newtonian material and the associated fabrication constraints such as injection velocity and cure time.

In one embodiment, the generative design module 110 includes a model configured to process user-defined input parameters, execute a 3D conditional diffusion process, and apply a structure representation method for generating consistent design outputs. In one embodiment, the model of the generative design module 110 may apply gradient-based or evolutionary algorithms.

The following are representative examples of input parameters that may be defined through the user interface 102 and processed by the generative design module 110. In one embodiment, the input parameters used in the generative design module 110 include material-specific and geometry-specific constraints such as strain rate sensitivity, target energy absorption, unit cell size, and overall structural density.

The strain rate sensitivity of the selected non-Newtonian material may range from 1 to 50, as determined by the ratio of the complex modulus at high and low strain rates (for example, at 3 Hz and 0.1 Hz, respectively). The target energy absorption may be at least 1 joule, depending on the application requirements. The unit cell size may fall within a range of 1 to 30 millimeters to allow fine-tuned structural control, while geometric constraints such as a density range of 100 to 2,000 kg/m³ and a minimum hole size of 0.01 mm are selected to balance energy absorption efficiency with manufacturability.

The database 120 serves as a material property database that stores the dataset that includes the experimentally derived rheological data of various non-Newtonian smart materials. The experimentally derived rheological data comprises at least the shear-rate-dependent viscosity curves, viscoelastic moduli, strain rate sensitivity profiles, and manufacturing parameters such as extrusion pressure, print speed, and cure time. In addition to acting as a centralized repository, the database 120 provides direct data access to the generative design module 110.

During the generation of candidate structures, the generative design module 110 retrieves relevant material attributes from the database 120 to guide the formation of geometry that is consistent with the physical behavior and fabrication constraints of the selected material.

Furthermore, the database 120 is configured to receive feedback from the FEA module 130. Simulation results that indicate discrepancies in predicted performance or material response are used to update or refine the stored dataset. This feedback mechanism allows the dataset to remain adaptive over time and contribute to the continued improvement of the design and simulation pipeline.

In one embodiment, the dataset stored in the database 120 includes information related to the rheological properties of non-Newtonian materials, structural design records, and dynamic response and performance data associated with previously evaluated configurations.

In one embodiment, the dataset stored in the database 120 may also include rheological data of non-Newtonian smart materials, including but not limited to polymeric formulations such as polyurethane, polydimethylsiloxane (PDMS), styrene-ethylene-butylene-styrene (SEBS), silicone gels, natural and synthetic rubber blends, and shear-thickening elastomers.

The FEA module 130 is configured to simulate energy absorption, deformation modes, and structural resilience under dynamic loading scenarios, such as drop impact or compression. The FEA module 130 incorporates nonlinear rheological models specific to non-Newtonian behavior, and performs simulations using the same voxel mesh resolution intended for 3D printing. This congruence between simulation and fabrication improves predictive accuracy and helps filter out design candidates that fail to meet performance thresholds under realistic manufacturing constraints.

The input for the FEA module 130 is derived directly from the structural outputs generated by the generative design module 110. Following simulation, if performance deviations, instability, or material misrepresentation are observed, the FEA module 130 can relay feedback to the database 120 to update the dataset stored therewithin, prompting refinement or expansion of the stored rheological profiles. This workflow allows the FEA module 130 to function not only as a validation stage for structures generated by the generative design module 110, but also as an adaptive quality gate that drives the ongoing accuracy and relevance of the material data housed in the dataset stored in the database 120.

In one embodiment, the FEA module 130 includes rheological models tailored to non-Newtonian materials and simulation routines for evaluating dynamic response and performance under specified loading conditions.

The optimization module 140 is configured to refine structural geometries based on simulation feedback received from the FEA module 130. The optimization module 140 employs an optimization algorithm to iteratively adjust key design parameters such as unit cell shape, spatial connectivity, and density gradients. The objective is to enhance energy absorption performance while satisfying additive manufacturing constraints, including feature resolution, injection velocity, and cure time. The optimized configuration is further provided back to the generative design module 110 as feedback.

In one embodiment, the generative design module 110 includes a comparator that evaluates the difference between the original design and the optimized version returned from the optimization module 140. If the comparator identifies that the deviation exceeds a predefined threshold in terms of geometry, material distribution, or other structural metrics, a notification is triggered to alert the user through the interface 102. This function allows users to identify significant changes that may affect the original design intent and decide whether to adjust the input parameters before proceeding.

The additive manufacturing module 150 is configured to fabricate the final optimized structure using a liquid deposition process that is compatible with high-viscosity, shear-sensitive non-Newtonian materials. The additive manufacturing module 150 receives the optimized design data from the optimization module 140 in the form of voxel-level structural information. The received data is translated into machine-executable fabrication instructions by the additive manufacturing module 150, which define the precise pathing and control sequences required for physical realization. The fabrication process is carried out under operational conditions that include parameters such as injection velocity, nozzle diameter, print speed, and curing temperature.

In one embodiment, the additive manufacturing module 150 implements a liquid deposition technology suitable for processing non-Newtonian materials with high viscosity and shear sensitivity; the additive manufacturing module 150 includes a material inlet configured to receive the printable formulation, a controlled extrusion nozzle for dispensing the material with precise pressure and velocity, and a movable build platform that supports layer-by-layer deposition. The operational settings of the nozzle, including extrusion rate, temperature, and motion path, are dynamically adjusted based on the design input.

Briefly, the generative design module 110 receives input parameters from the user interface 102, including material properties, loading conditions, and geometric constraints, and generates initial structural candidates using a 3D conditional diffusion model. During this process, the generative design module 110 retrieves relevant rheological and processing data from the database 120 to guide the generation of designs that align with the physical behavior of the selected non-Newtonian material. The structure features, such as unit cell size, density, hole size, and shape, are determined with reference to the material's rheological characteristics and fabrication constraints, including injection velocity and cure time.

The FEA module 130 simulates the mechanical performance of the generated designs under dynamic loading using non-Newtonian material models. The simulation is performed using the same voxel mesh resolution intended for additive manufacturing. Based on the simulation results, the optimization module 140 iteratively refines the design to improve energy absorption and ensure compatibility with manufacturing requirements. The final optimized design is then transmitted to the additive manufacturing module 150, which fabricates the structure using a liquid deposition process aligned with the material's viscosity and shear sensitivity.

Within the above-described workflow, the present invention further provides a method for generative design and additive manufacturing of non-Newtonian smart materials. This method includes the following key steps: (1) defining input parameters for the generative design module; (2) generating candidate structural designs using the generative design module; (3) converting the generated designs into signed distance field (SDF) representations; (4) simulating the mechanical performance of the candidate designs using the FEA module with material models specific to non-Newtonian behavior; (5) optimizing the designs based on the simulation results using the optimization module; and (6) fabricating the optimized structure using the additive manufacturing module. The provided integrated sequence enables a data-driven, automated design and fabrication process for complex energy-absorbing structures. Compared to conventional approaches, the provided method offers enhanced energy absorption capability, improved adaptability to material-specific constraints, reduced design cycle time, and the ability to produce application-specific, performance-optimized structures with high fidelity.

The following provides further descriptions of the functions and internal elements of the generative design module 110 and the optimization module 140.

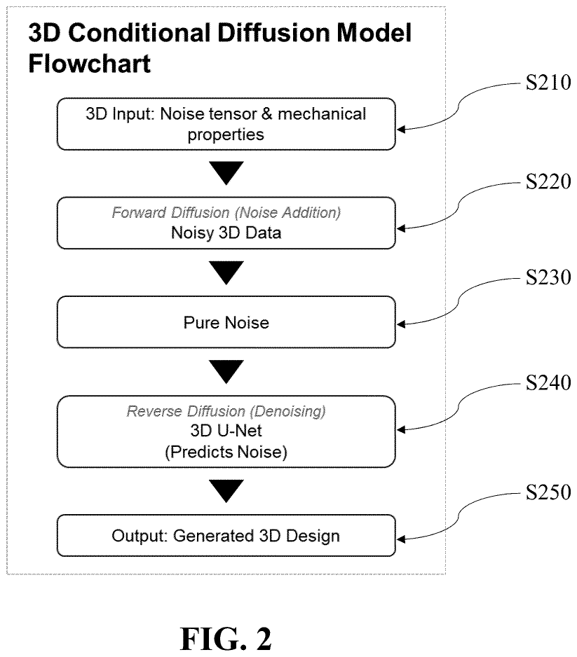

FIG. 2 is a flowchart illustrating an internal process of a 3D conditional diffusion model implemented within the generative design module 110 according to one embodiment. The 3D conditional diffusion model at least performs five steps for the generation of the 3D design.

Step S210 involves receiving a 3D input that includes a noise tensor and mechanical property conditions. In one embodiment, the 3D conditional diffusion model receives an input that includes a noise tensor and one or more mechanical property conditions. The mechanical property inputs may include parameters such as strain rate sensitivity, target modulus range, or rheological thresholds associated with a selected non-Newtonian material. These properties are retrieved from the database 120, which provides material-specific information to condition the design generation process. This enables the model to initiate structure synthesis within the bounds of material feasibility and application requirements.

Step S220 involves forward diffusion, a process that introduces noise into the structural representation. During the forward diffusion phase, the 3D conditional diffusion model incrementally adds noise to the initial 3D structural representation, gradually transforming the structured data into a fully randomized state. This process is carried out internally within the generative design module 110 and does not require external data input. The purpose of this stage is to prepare the input for the subsequent reverse denoising procedure while retaining conditioning information.

Step S230 involves pure noise. At the terminal point of the forward diffusion process, the structure is represented as pure noise. This latent representation serves as the starting point for the reverse diffusion phase. The pure noise state contains no explicit structural information but remains implicitly conditioned by the material and performance parameters defined at the input stage.

Step S240 involves reverse diffusion through denoising executed by a 3D U-Net model. In the reverse diffusion phase, a trained 3D U-Net is applied to predict the underlying structural geometry from the noise-laden representation in a step-wise manner. This prediction process is driven by a deep learning model that has learned, through prior training, to reconstruct complex spatial patterns that are mechanically and materially feasible. The 3D U-Net architecture, which extends the standard U-Net to volumetric data domains, is particularly suited for modeling three-dimensional structures with high spatial resolution. Its encoder-decoder design with skip connections allows the model to capture both global context and local geometric detail. The 3D U-Net performs as an AI-based generative engine, enabling the system to synthesize structural candidates that conform to the conditioning inputs, such as rheological parameters and design constraints. The predictive capability of the 3D U-Net model enables the generation of non-trivial, mechanically compliant geometries that would be difficult to design using rule-based or purely parametric methods. Although the denoising phase does not actively query external data during inference, the 3D U-Net model may be pre-trained on data sourced from the dataset stored in the database 120, including previously validated structures and their associated performance records.

Step S250 involves outputting the generated 3D design. Upon completion of the denoising process, the 3D conditional diffusion model outputs a 3D design that reflects both geometric constraints and material-aware considerations. The resulting structure is produced through the combined effect of the model's predictive capability and the mechanical property inputs retrieved from the database 120.

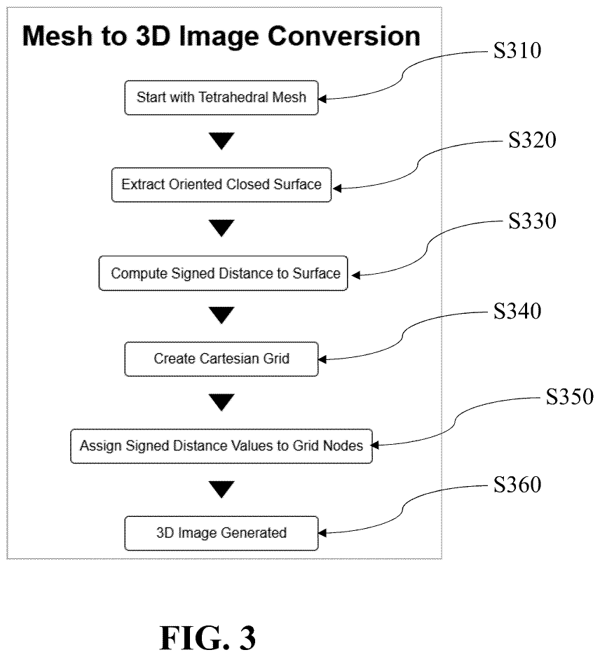

FIG. 3 is a flowchart illustrating a mesh-to-3D image conversion process performed within the generative design module 110 according to one embodiment. This process involves six steps, including extracting the oriented closed surface of each structure and calculating the SDFs for points on a Cartesian grid from mesh representation, thereby generating a 3D image based on SDFs. Also, the structure's shape and topology is accurately represented using an algorithm.

Step S310 involves starting with a tetrahedral mesh representation of a candidate design. This mesh is generated by the 3D conditional diffusion model described in FIG. 2 and encodes the geometry of the structure through volumetric elements.

Step S320 involves extracting the oriented closed surface from the tetrahedral mesh. In this step, the outer surface boundary of the mesh is identified and extracted in a way that preserves the orientation of surface normals, which is essential for accurate signed distance calculations.

Step S330 involves computing the signed distance to the surface based on the extracted geometry. The signed distance from each point in space to the nearest point on the surface is calculated using an algorithm which provides efficient and accurate evaluation of winding numbers and distance fields.

Step S340 involves creating a Cartesian grid that encompasses the bounding volume of the extracted surface. The grid is discretized into uniformly spaced nodes, each of which serves as a sampling location for storing geometric distance data.

Step S350 involves assigning signed distance values to the grid nodes. For each node in the Cartesian grid, a signed scalar value is assigned based on its relative position to the extracted surface. Positive values indicate points outside the surface, while negative values indicate points inside the structure.

Step S360 involves generating the final 3D image based on the signed distance field. The completed 3D image serves as a unified geometric representation that enables downstream modules (e.g., the FEA module 130 and the optimization module 140) to evaluate, compare, and manipulate structural designs independent of their original mesh topology.

In one embodiment, the generative design module 110 is configured to generate at least two candidate structures per iteration, enabling parallel evaluation and comparative optimization across multiple design paths.

In one embodiment, the FEA module 130 operates in conjunction with optimization algorithms to form a closed feedback loop for iterative design refinement. After the initial structure is generated and converted into a signed distance field as described in FIG. 3, the FEA module 130 evaluates the structural response under specified loading conditions using material models specific to the selected non-Newtonian formulation. The performance data produced by this simulation is transmitted to the optimization module 140, which adjusts the design accordingly. Through the feedback process, the system 100 iteratively modifies and re-evaluates the structure to improve both energy absorption and manufacturability. The optimization logic may dynamically update structural parameters such as unit cell size, density, hole size, and shape, based on the rheological and mechanical properties retrieved from database 120.

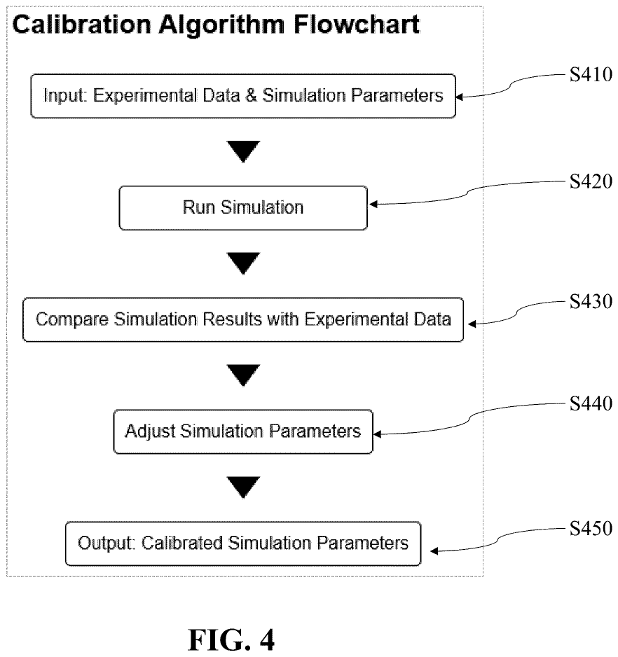

FIG. 4 is a flowchart illustrating a calibration algorithm process implemented within the optimization module 140 according to one embodiment. This process involves measuring the rheological properties of non-Newtonian materials, such as shear-rate-dependent viscosity and viscoelastic behavior, ensuring the simulation's accuracy and alignment with real-world manufacturing conditions.

Step S410 involves receiving experimental data and initial simulation parameters. The experimental data may include measured responses of non-Newtonian materials under controlled loading conditions, such as stress-strain curves, energy absorption values, or viscoelastic behavior. The simulation parameters may include initial estimates for rheological constants, boundary conditions, and material coefficients used in the FEA module 130.

Step S420 involves running the simulation using the received parameters. The optimization module 140 collaborates with the FEA module 130 to perform the simulation, generating predicted structural responses for subsequent comparison with experimental data.

Step S430 involves comparing the simulation results with the experimental data. The system evaluates differences between predicted and observed behaviors, such as deviations in energy absorption, deformation profiles, or failure modes.

Step S440 involves adjusting the simulation parameters based on the identified discrepancies. Parameter tuning may include modifying viscosity curves, updating constitutive models, or refining meshing density and solver tolerances to better reflect physical reality.

Step S450 involves outputting the calibrated simulation parameters. These parameters are stored for use in subsequent simulations.

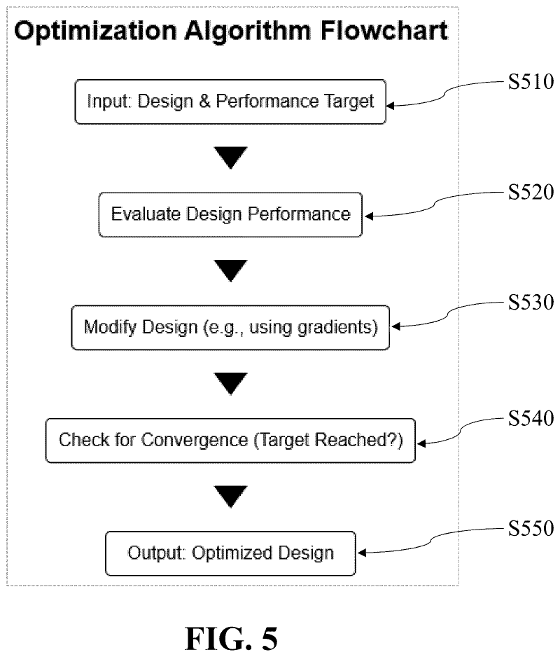

FIG. 5 is a flowchart illustrating an optimization algorithm process performed within the optimization module 140 according to one embodiment. Following the calibration procedure described in FIG. 4, the optimization module 140 refines structural designs generated by the generative design module 110 based on performance targets and simulation results obtained from the FEA module 130. By applying specific algorithms, such as gradient-based optimization, the module iteratively adjusts design parameters to improve energy absorption performance while also minimizing design time and computational cost.

Step S510 involves receiving an input design and a corresponding performance target. The input design may be a candidate structure previously evaluated by the FEA module 130 using simulation parameters calibrated through the process described in FIG. 4. The performance target may include energy absorption thresholds, deformation limits, or manufacturing constraints.

Step S520 involves evaluating the performance of the current design. This evaluation may be based on simulation data obtained from the FEA module 130 or internal performance prediction metrics. The optimization module 140 assesses how closely the current design satisfies the desired functional objectives, such as energy absorption efficiency or stress distribution.

Step S530 involves modifying the design based on the evaluation results. In one embodiment, this step includes applying gradient-based or heuristic optimization techniques to adjust design variables such as unit cell geometry, material distribution, or topological features. The updated design is intended to improve performance while maintaining manufacturability.

Step S540 involves checking for convergence. The optimization module 140 determines whether the modified design meets the predefined performance target within an acceptable tolerance. If the target is not yet reached, the process loops back to step S520 for further refinement.

Step S550 involves outputting the optimized design. Once convergence is achieved, the final design is transmitted to downstream modules for fabrication. Upon completion of step S550, the finalized design is evaluated against manufacturing constraints to verify its feasibility. Once confirmed, the optimization module 140 compiles the design and its associated processing parameters into a structured data package, which is then transmitted to the additive manufacturing module 150 to initiate the fabrication process, thereby generating a physical product.

In the present invention, the generative design module 110 adopts an AI-driven approach, specifically implementing a 3D conditional diffusion model to synthesize design candidates that are responsive to material properties and fabrication constraints. The AI-based mechanism allows the system to explore complex design spaces beyond the reach of traditional rule-based or parametric methods, particularly when dealing with the nonlinear, strain-rate-dependent behavior of non-Newtonian smart materials. By integrating the AI generation capability with the finite element analysis module 130 and the optimization module 140, the system 100 establishes a data-driven feedback loop in which generated designs are rigorously evaluated and iteratively refined. The simulation results provide accurate predictions of energy absorption and deformation, while the optimization algorithms adjust geometric features to enhance structural performance and manufacturability.

The use of AI in the generative design module 110 is particularly well-suited for a feedback-driven and iterative design workflow. Unlike static design methods, AI-based generative models are capable of dynamically adapting to performance evaluations and constraint updates received from other modules in the system. When integrated with the FEA module 130 and the optimization module 140, the AI model can incorporate simulation results and optimization feedback to continuously improve design outputs in response to real-time performance data. This adaptive capability supports efficient convergence toward high-performing structures, especially in applications involving non-Newtonian materials, where the design-performance relationship is highly nonlinear and sensitive to manufacturing conditions. The iterative nature of the design loop benefits from the AI model's ability to generate diverse, yet constraint-compliant, structural candidates with each cycle, thereby enhancing the system's ability to explore, learn from, and refine within a complex design space.

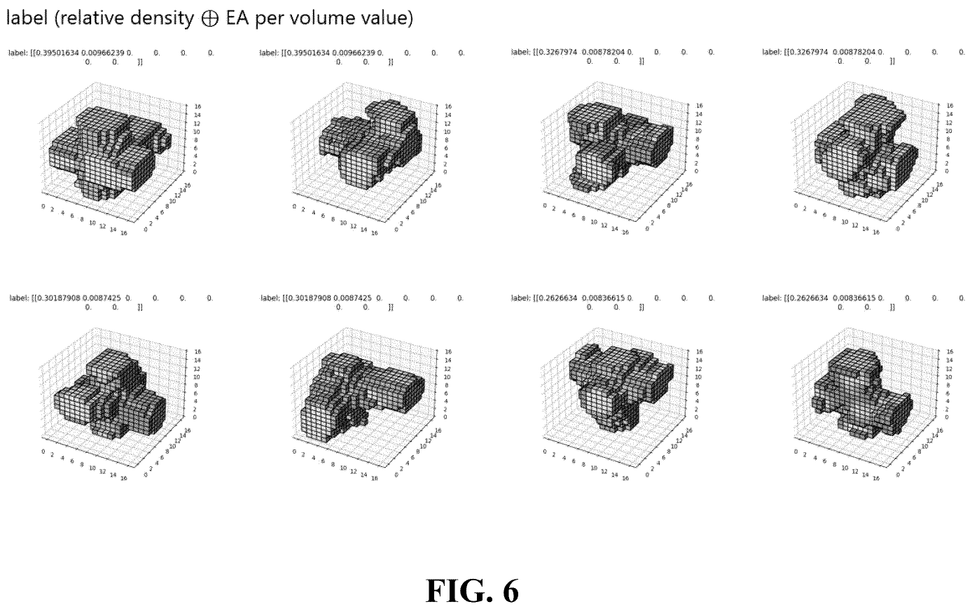

FIG. 6 provides an example of an optimized design. The illustrated voxel-based structures represent generative outputs that are labeled with relative density and energy absorption per unit volume. These examples reflect structural configurations that are generated and evaluated during the design process described in the present invention.

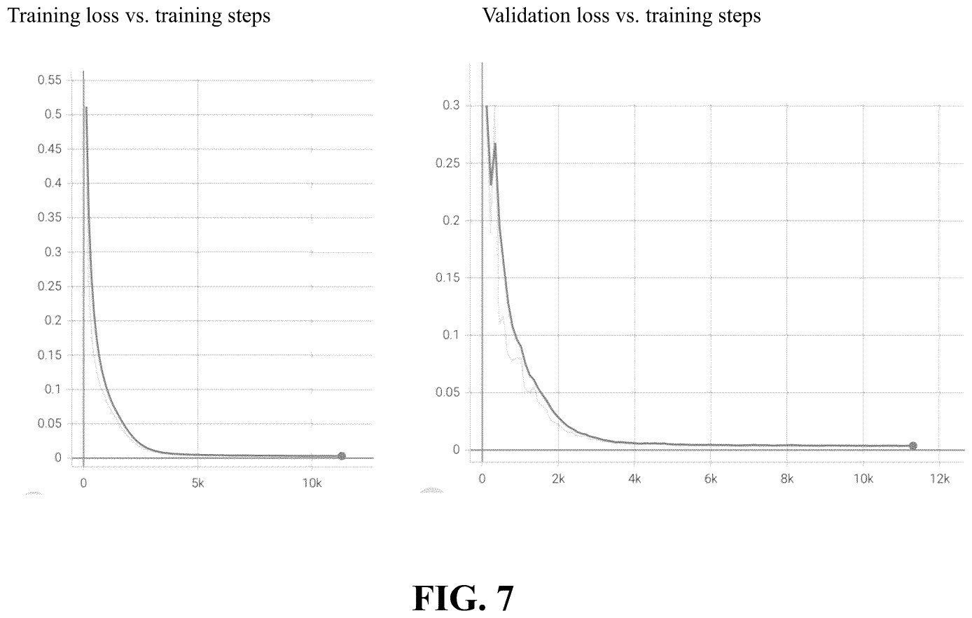

FIG. 7 shows the training loss and validation loss curves of the AI model used in the generative design module 110. The curves demonstrate progressive loss reduction over training steps, indicating that the model was effectively trained to generalize across structural examples.

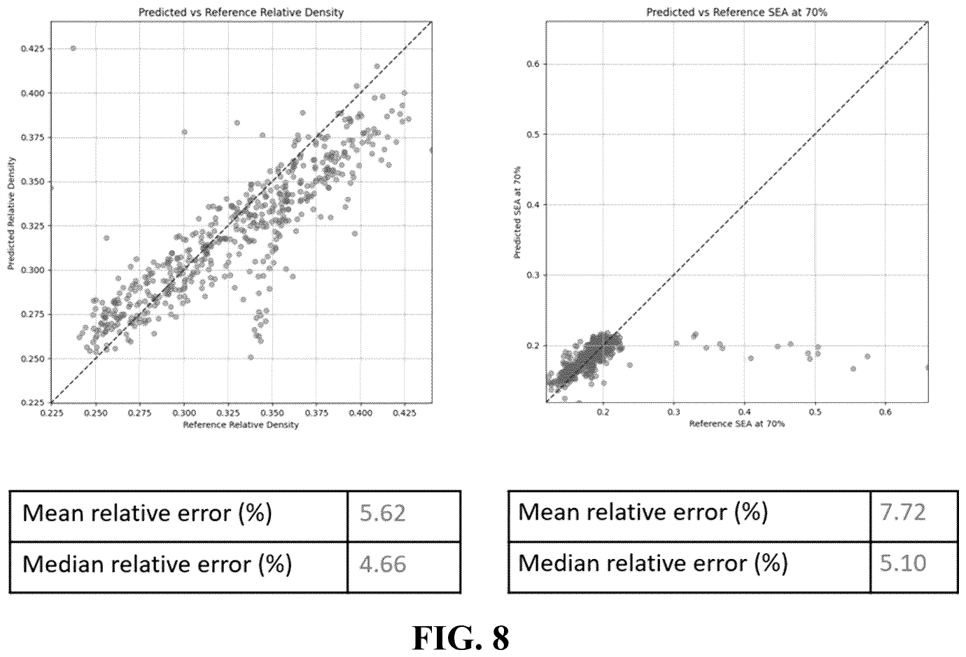

FIG. 8 illustrates the prediction performance of the AI model used in the generative design module 110. The left chart shows predicted versus reference values for relative density, and the right chart shows predicted versus reference values for specific energy absorption (SEA) at 70% strain. The corresponding mean and median relative errors indicate that the model can reasonably estimate structural performance indicators based on geometric input.

### EXAMPLE

### Example 1

### Generative Design and Simulation of a Non-Newtonian Energy-Absorbing Structure

A non-Newtonian energy-absorbing structure is designed using the generative design module. The generative design module produced several candidate designs, each represented as voxel meshes.

Input parameters include a density of at least 0.05, a target energy absorption capacity of 5 J, and geometric constraints limiting the unit cell size to 4 mm.

The designs are converted into SDFs for analysis. Using the FEA module, each design is simulated under a dynamic loading condition of 2.5 kg mass dropped with an impact energy of 5J. The optimization module iteratively refined the top several designs, improving the energy absorption capacity by at least 5%.

The optimized design, characterized by a unit cell density of at least 100 kg/m³ and a mean hole size of at least 0.1 mm, exhibited an energy absorption capacity of at least 1 J, surpassing the prior art by at least 5%.

### Example 2

### Calibration and Fabrication of a Non-Newtonian Structure

The rheological properties of a non-Newtonian material are measured to calibrate the system. The material demonstrated a shear-rate-dependent viscosity ranging from 10⁴ Pa·s at a shear rate of 1 s⁻¹ to 10⁻³ Pa·s at a shear rate of 100 s⁻¹. Viscoelastic properties were evaluated, revealing a storage modulus of 0.5-1.5 MPa and a loss modulus of 0.1-0.2 MPa.

These properties are input into the FEA module to simulate the performance of an optimized design. The design was fabricated using a liquid deposition additive manufacturing process with an injection velocity of 1000-3000 mm/s and a cure time of 120-240 seconds at 70~90 degrees Celsius (e.g. 80 degrees Celsius). The final structure achieved an energy absorption efficiency of at least 5%, demonstrating the system's capability to translate design into high-performance materials.

A comparative experiment is conducted to evaluate the energy absorption performance of the invention against prior art materials. A non-Newtonian material structure, optimized using the generative design module, was tested under a dynamic loading condition of 2.5 kg mass dropped with an impact energy of 5J. The optimized structure absorbed % more energy compared to a conventional honeycomb structure with similar density (kg/m³). Additionally, the structure designed using the present invention demonstrated improved stability.

### Example 3

### Application in Protective Equipment

Prototype anti-impact gloves are designed using the system. The target performance metrics included an energy absorption threshold of 5 J and a maximum allowable transmitted force of 4 kN. Using the system, a non-Newtonian material structure was optimized to meet these criteria. The fabricated gloves are tested in drop tests with 2.5 kg mass, simulating an impact force of at least 1 N.

### Example 4

### Application in Aerospace Structures

A lightweight aerospace panel is designed using the generative design module and fabricated using the additive manufacturing module. The resulting panel, composed of a non-Newtonian energy-absorbing lattice, achieves a weight reduction of at least 1% compared to conventional aluminum honeycomb panels, while maintaining equivalent impact resistance under standardized test conditions.

In one embodiment, the resulting optimized structure comprises unit cells with a size within the range of 1 to 30 mm and a bulk density ranging from 100 to 2000 kg/m³, consistent with the geometric constraints applied during generative design.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments are chosen and described in order to best explain the principles of the invention and its practical application, thereby enabling others skilled in the art to understand the present invention for various embodiments and with various modifications that are suited to the particular use contemplated.

### Definition

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5% of the average of the values.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

The term “signed distance fields (SDFs)” is used to evaluate structural integrity and performance under different loading conditions specific to non-Newtonian materials.

The “Cartesian grid” is defined within a bounding volume containing the candidate design structure, and the signed distance is computed for each grid point relative to the nearest surface point.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

### References: The Disclosures of the Following References are Incorporated by Reference

Barill, G., Dickson, N. G., Schmidt, R., Levin, D. I. W., & Jacobson, A. (2018). Fast winding numbers for soups and clouds. ACM Transactions on Graphics, 37(4). https://doi.org/10.1145/3197517.3201337.

The functional units and modules of the systems and methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes executing in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can be included, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A system for designing and manufacturing non-Newtonian energy-absorbing structures, the system being configured to receive user-defined input parameters and to generate physical structures through an integrated design-to-fabrication workflow and comprising:
a user interface configured to receive input parameters comprising material properties, loading conditions, and geometric constraints and to convert the input parameters into structured data;
a generative design module configured to receive the structured data and to generate candidate structures using a 3D conditional diffusion model that synthesizes voxel-based geometries based on physical and rheological characteristics of a selected non-Newtonian material;
a database configured to store a dataset comprising experimentally derived rheological data, comprising viscosity curves, viscoelastic moduli, and manufacturing parameters; the database is further configured to provide the stored dataset to the generative design module during generation to the candidate structures; and
a finite element analysis (FEA) module configured to simulate mechanical performance of the candidate structures using material models specific to non-Newtonian behavior and a voxel mesh resolution consistent with an additive manufacturing process.

2. The system of claim 1, wherein the FEA module is further configured to transmit performance evaluation results to the generative design module, and wherein the generative design module is configured to receive the evaluation results as feedback to guide subsequent design iterations for the candidate structures.

3. The system of claim 2, further comprising:
an optimization module configured to receive simulation results from the FEA module and to iteratively refine structural geometry of the candidate structures based on energy absorption performance and fabrication constraints, thereby generating an optimized structure; and
an additive manufacturing module configured to fabricate the optimized structure using a liquid deposition process with settings that accommodate the shear-sensitive and high-viscosity properties of the selected non-Newtonian material.

4. The system of claim 3, wherein the optimization module is configured to transmit a refined structure to the generative design module as feedback, and wherein the generative design module is configured to update subsequent design outputs based on the refined structure, thereby forming a feedback loop between the optimization module and the generative design module.

5. The system of claim 1, wherein the 3D conditional diffusion model performs a forward diffusion process to progressively transform structured input into a noise representation, followed by a reverse diffusion process using a trained 3D U-Net to reconstruct a structural geometry that complies with the conditioning inputs.

6. The system of claim 1, wherein the generative design module converts the generated structures into signed distance field (SDF) representations by extracting oriented closed surfaces and computing signed distances for points on a Cartesian grid.

7. The system of claim 1, wherein the non-Newtonian material comprises at least one of polyurethane, polydimethylsiloxane (PDMS), styrene-ethylene-butylene-styrene (SEBS), silicone gel, natural rubber, synthetic rubber, or shear-thickening elastomer.

8. The system of claim 1, wherein a voxel mesh used in the FEA module matches a resolution used in the additive manufacturing module to maintain fidelity between simulation and fabrication.

9. A method for designing and manufacturing non-Newtonian energy-absorbing structures, the method comprising receiving user-defined input parameters and generating physical structures through an integrated design-to-fabrication workflow, comprising:
receiving, by a user interface, input parameters comprising material properties, loading conditions, and geometric constraints and to convert the input parameters into structured data;
receiving, by a generative design module, the structured data;
generating, by the generative design module, candidate structures using a 3D conditional diffusion model that synthesizes voxel-based geometries based on physical and rheological characteristics of a selected non-Newtonian material;
storing, in a database, a dataset comprising experimentally derived rheological data comprising viscosity curves, viscoelastic moduli, and manufacturing parameters;
providing, by the database, the stored dataset to the generative design module during generation to the candidate structures; and
simulating, by a finite element analysis (FEA) module, mechanical performance of the candidate structures using material models specific to non-Newtonian behavior and a voxel mesh resolution consistent with an additive manufacturing process.

10. The method of claim 9, further comprising:
transmitting, by the FEA module, performance evaluation results to the generative design module; and
receiving, by the generative design module, the evaluation results as feedback to guide subsequent design iterations for the candidate structures.

11. The method of claim 10, further comprising:
receiving simulation results from the FEA module and iteratively refining structural geometry of the candidate structures based on energy absorption performance and fabrication constraints by an optimization module, thereby generating an optimized structure; and
fabricating, by an additive manufacturing module, the optimized structure using a liquid deposition process with settings that accommodate the shear-sensitive and high-viscosity properties of the selected non-Newtonian material.

12. The method of claim 11, further comprising:
transmitting, by the optimization module, a refined structure to the generative design module as feedback; and
updating, by the generative design module, subsequent design outputs based on the refined structure, thereby forming a feedback loop between the optimization module and the generative design module.

13. The method of claim 11, further comprising:
fabricating the optimized structure by operating the additive manufacturing module with an injection velocity ranging from 1000 to 3000 millimeters per second, a cure time ranging from 120 to 240 seconds, and a temperature ranging from 70 to 90 degrees Celsius, thereby generating a physical product.

14. The method of claim 13, wherein the physical product exhibits an energy absorption efficiency of at least 5 percent under dynamic loading conditions.

15. The method of claim 13, further comprising:
testing the physical product under a drop impact condition involving a 2.5-kilogram mass released with an impact energy of at least 5 joules, wherein the physical product undergoes controlled deformation.

16. The method of claim 13, wherein the physical product comprises unit cells having a size ranging from 1 to 30 millimeters and a density ranging from 100 to 2000 kilograms per cubic meter.

17. The method of claim 9, wherein the 3D conditional diffusion model performs a forward diffusion process to progressively transform structured input into a noise representation, followed by a reverse diffusion process using a trained 3D U-Net to reconstruct a structural geometry that complies with the conditioning inputs.

18. The method of claim 9, further comprising:
converting, by the generative design module, the generated structures into signed distance field (SDF) representations by extracting oriented closed surfaces and computing signed distances for points on a Cartesian grid.

19. The method of claim 9, wherein a voxel mesh used in the FEA module matches a resolution used in the additive manufacturing module to maintain fidelity between simulation and fabrication.

20. The method of claim 9, wherein the non-Newtonian material comprises at least one of polyurethane, polydimethylsiloxane (PDMS), styrene-ethylene-butylene-styrene (SEBS), silicone gel, natural rubber, synthetic rubber, or shear-thickening elastomer.
